(19) United States
(12) Patent Application Publication
(10) Pub. No.: US 2023/0065956 A1
(43) Pub. Date: Mar. 2, 2023

(54) DETECTION DEVICE AND NON-TRANSITORY COMPUTER READABLE MEDIUM

(71) Applicant: FUJIFILM BUSINESS INNOVATION CORP., Tokyo (JP)

(72) Inventors: Hiroyuki SUZUKI, Kanagawa (JP); Naohito OTSUKI, Kanagawa (JP); Takehiko KOIZUMI, Kanagawa (JP); Yuta CHINO, Kanagawa (JP)

(73) Assignee: FUJIFILM BUSINESS INNOVATION CORP., Tokyo (JP)

(21) Appl. No.: 17/714,304

(22) Filed: Apr. 6, 2022

(30) Foreign Application Priority Data
Aug. 25, 2021 (JP) 2021-137601

(51) Int. Cl. B41J 11/00; B41J 11/42; B65H 7/08; B65H 7/10

(52) U.S. Cl. CPC B41J 11/0095; B41J 11/42; B65H 7/08; B65H 7/10; B65H 2801/03; B65H 2511/20

(57) ABSTRACT

A detection device includes a first detection unit that detects a leading edge portion and a trailing edge portion of a medium while the medium is being transported, and a second detection unit that detects both edge portions of the medium in an orthogonal direction that is orthogonal to a transporting direction of the medium while the medium is being transported.

### CROSS-REFERENCE TO RELATED APPLICATIONS

This application is based on and claims priority under 35 USC 119 from Japanese Patent Application No. 2021-137601 filed Aug. 25, 2021.

### BACKGROUND

### (i) Technical Field

The present disclosure relates to a detection device and a non-transitory computer readable medium.

### (ii) Related Art

Japanese Patent No. 4133702 discloses an image forming apparatus including an image forming unit that forms an image, a sheet reversing unit used to perform double-sided printing, a guide unit used to retain the position of a paper sheet in the sheet reversing unit, and a sheet-position retaining unit. A paper sheet whose length in a transporting direction thereof is longer than the length of a transport passage in the sheet reversing unit may be transported into the transport passage. In such a case, the sheet-position retaining unit continuously retains the position of the paper sheet with the guide unit from when the paper sheet has entirely entered the transport passage and when the transportation of the paper sheet is stopped so that a trailing edge of the paper sheet is at a reversing start position. Then, when the next image forming operation is ready to be started, the sheet-position retaining unit stops retaining the position of the paper sheet and releases the paper sheet.

Japanese Unexamined Patent Application Publication No. 2017-114659 discloses a sheet-length measurement device including a rotating body that rotates in contact with a sheet material, a measurement mechanism that measures an amount of rotation of the rotating body, and position sensing mechanisms disposed upstream and downstream of the rotating body in a transporting direction of the sheet material. Each of the position sensing mechanisms includes a sensing member line including plural sensing members arranged in a line. Each position sensing mechanism is disposed to cross side edges of the sheet material in a width direction, and is at an angle with respect to the transporting direction of the sheet material. A sheet length of the sheet material is determined based on the amount of rotation of the rotating body measured by the measurement mechanism and positions of edge portions of the sheet material sensed by the position sensing mechanisms.

### SUMMARY

Aspects of non-limiting embodiments of the present disclosure relate to a detection of positions of both edge portions of a medium in a direction orthogonal to a transporting direction of a medium while the medium is being transported. The detection is performed with increased accuracy compared to a case in which a length of the medium in the direction orthogonal to the transporting direction is estimated based on a length of the medium in the transporting direction determined by detecting a leading edge portion and a trailing edge portion of the medium while the medium is being transported.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a detection device including a first detection unit that detects a leading edge portion and a trailing edge portion of a medium while the medium is being transported, and a second detection unit that detects both edge portions of the medium in an orthogonal direction that is orthogonal to a transporting direction of the medium while the medium is being transported.

### BRIEF DESCRIPTION OF THE DRAWINGS

An exemplary embodiment of the present disclosure will be described in detail based on the following figures, wherein:

FIG. 1 is a schematic diagram illustrating the structure of an image forming apparatus according to an exemplary embodiment;

FIG. 2 is a schematic diagram illustrating the structure of the image forming apparatus according to the exemplary embodiment in which an electrophotographic image forming unit is used;

FIG. 3 is a schematic diagram illustrating the structure of the image forming apparatus according to the exemplary embodiment in which a medium storage unit is disposed on a side of a transport path;

FIG. 4 is a side sectional view illustrating the structure of a detection device according to the exemplary embodiment;

FIG. 5 is a plan view illustrating the structure of the detection device according to the exemplary embodiment;

FIG. 6 is a side sectional view illustrating the structure of the detection device according to the exemplary embodiment;

FIG. 7 is a block diagram illustrating an example of a hardware configuration of a control device according to the exemplary embodiment;

FIG. 8 is a block diagram illustrating an example of a functional configuration of a processor included in the control device according to the exemplary embodiment;

FIG. 9 is a timing chart of the detection device according to the exemplary embodiment;

FIG. 10 is a diagram used to describe a measurement of a transporting-direction dimension of a medium having a cutting error;

FIG. 11 is a diagram used to describe a measurement of a transporting-direction dimension of a medium that is skewed;

FIG. 12 is a diagram used to describe a measurement of a width-direction dimension of a medium;

FIG. 13 is a diagram illustrating detection of side edge portions of the medium at a downstream side of the medium in the transporting direction; and

FIG. 14 is a diagram illustrating detection of side edge portions of the medium at an upstream side of the medium in the transporting direction.

### DETAILED DESCRIPTION

An exemplary embodiment of the present disclosure will now be described with reference to the drawings.

### Image Forming Apparatus 10

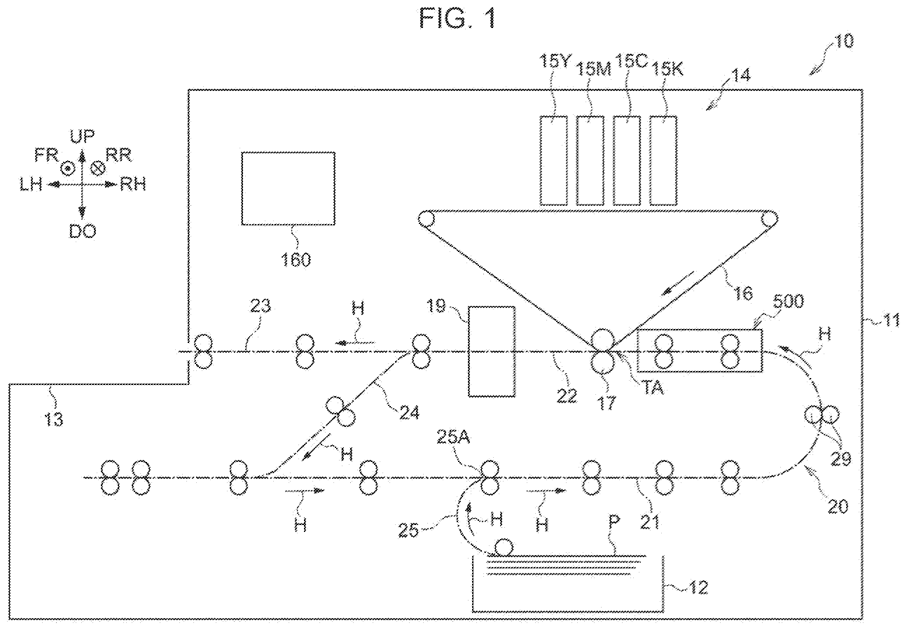

The structure of an image forming apparatus 10 according to the exemplary embodiment will be described. FIG. 1 is a schematic diagram illustrating the structure of the image forming apparatus 10 according to the present exemplary embodiment.

In the drawings, arrow UP shows an upward (vertically upward) direction of the apparatus, and arrow DO shows a downward (vertically downward) direction of the apparatus. In addition, arrow LH shows a leftward direction of the apparatus, and arrow RH shows a rightward direction of the apparatus. In addition, arrow FR shows a forward direction of the apparatus, and arrow RR shows a rearward direction of the apparatus. These directions are defined for convenience of description, and the structure of the apparatus is not limited to theses directions. The directions of the apparatus may be referred to without the term “apparatus”. For example, the “upward direction of the apparatus” may be referred to simply as the “upward direction”.

In addition, in the following description, the term “up-down direction” may be used to mean either “both upward and downward directions” or “one of the upward and downward directions”. The term “left-right direction” may be used to mean either “both leftward and rightward directions” or “one of the leftward and rightward directions”. The left-right direction may also be referred to as a lateral direction or a horizontal direction. The term “front-rear direction” may be used to mean either “both forward and rearward directions” or “one of the forward and rearward directions”. The front-rear direction corresponds to a width direction described below, and may also be referred to as a lateral direction or a horizontal direction. The up-down direction, the left-right direction, and the front-rear direction cross each other (more specifically, are orthogonal to each other).

In the figures, a circle with an X in the middle represents an arrow going into the page, and a circle with a dot in the middle represents an arrow coming out of the page.

The image forming apparatus 10 illustrated in FIG. 1 is an apparatus that forms an image. More specifically, the image forming apparatus 10 is an inkjet image forming apparatus that forms an image on a medium P by using ink. Still more specifically, as illustrated in FIG. 1, the image forming apparatus 10 includes an image forming apparatus body 11, a medium storage unit 12, a medium output unit 13, an image forming unit 14, a heating unit 19, a transport mechanism 20, a detection device 500, and a control device 160.

The medium P, components of the image forming apparatus 10, an image forming operation performed by the image forming apparatus 10, etc., will now be described.

### Medium P

The medium P is an object on which an image is formed by the image forming unit 14. The medium P may be, for example, a paper sheet or a film. The paper sheet may be, for example, a sheet of cardboard paper or coated paper. The film may be, for example, a resin film or a metal film. In the present exemplary embodiment, a paper sheet, for example, is used as the medium P. The type of the medium P is not limited to the above-described types, and various types of media P may be used.

The size of the medium P may be, for example, greater than A3, and sizes such as A2, A1, A0, and B series may be used. The size of the medium P is not limited to the above-described sizes, and media P having various sizes may be used.

A length of the medium P in a transporting direction will be referred to as a transporting-direction dimension. A direction that crosses (more specifically, that is orthogonal to) the transporting direction of the medium P will be referred to as a width direction, and a length of the medium P in the width direction will be referred to as a width-direction dimension. The width direction is an example of an orthogonal direction. In the figures, the transporting direction is shown by arrow H as appropriate.

In the present exemplary embodiment, an upstream edge portion of the medium P in the transporting direction may be referred to as a trailing edge portion or an upstream edge portion. A downstream edge portion of the medium P in the transporting direction may be referred to as a leading edge portion or a downstream edge portion. Edge portions of the medium P in the width direction may be referred to as side edge portions.

### Image Forming Apparatus Body 11

As illustrated in FIG. 1, components of the image forming apparatus 10 are disposed in the image forming apparatus body 11. More specifically, for example, the medium storage unit 12, the image forming unit 14, the heating unit 19, the transport mechanism 20, and the detection device 500 are disposed in the image forming apparatus body 11.

The detection device 500 is removably disposed in the image forming apparatus body 11. In other words, the detection device 500 is detachably attached to the image forming apparatus body 11.

### Medium Storage Unit 12

The medium storage unit 12 is a unit that stores media P in the image forming apparatus 10. The media P stored in the medium storage unit 12 are supplied to the image forming unit 14.

### Medium Output Unit 13

The medium output unit 13 is a unit of the image forming apparatus 10 to which each medium P is output. The medium output unit 13 receives the medium P having an image formed thereon by the image forming unit 14.

### Image Forming Unit 14

The image forming unit 14 illustrated in FIG. 1 is an example of an image forming unit that forms an image on the medium P transported thereto. More specifically, the image forming unit 14 forms an image on the medium P by using ink. Still more specifically, as illustrated in FIG. 1, the image forming unit 14 includes discharge portions 15Y, 15M, 15C, and 15K (hereinafter denoted by 15Y to 15K), a transfer body 16, and a facing member 17 that faces the transfer body 16.

In the image forming unit 14, the discharge portions 15Y to 15K discharge ink droplets of respective colors, which are yellow (Y), magenta (M), cyan (C), and black (K), toward the transfer body 16 to form images on the transfer body 16. In addition, in the image forming unit 14, the images of respective colors formed on the transfer body 16 are transferred to the medium P that passes through a transfer position TA between the transfer body 16 and the facing member 17. As a result, an image is formed on the medium P. The transfer position TA may be regarded as an image formation position at which the image is formed on the medium P.

An example of the image forming unit does not necessarily have the structure of the image forming unit 14. For example, an example of the image forming unit may instead be structured such that the discharge portions 15Y to 15K discharge ink droplets directly toward the medium P instead of the transfer body 16.

### Image Forming Unit 214

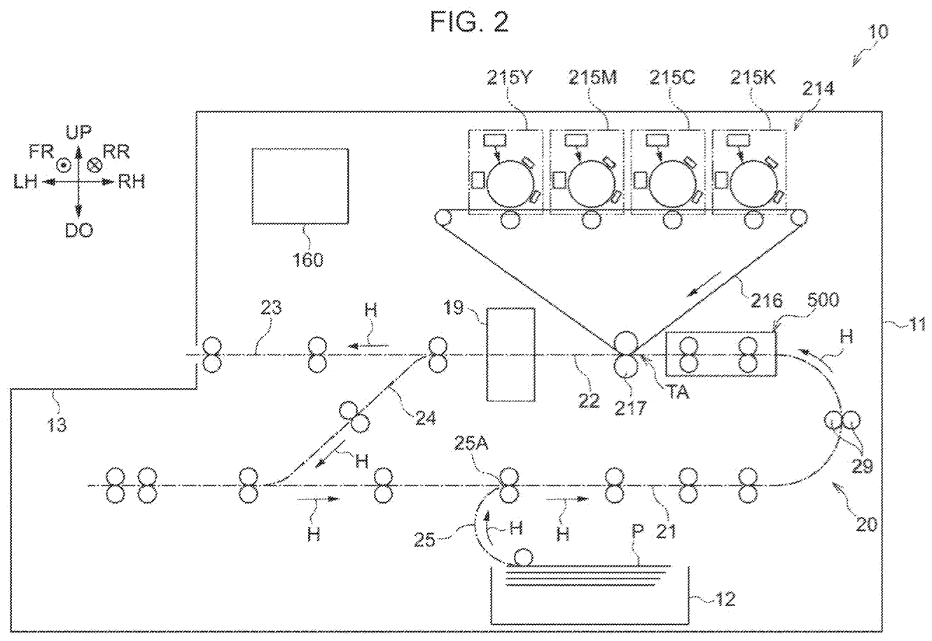

As illustrated in FIG. 2, an example of the image forming unit may instead be an electrophotographic image forming unit 214 that forms an image on the medium P by using toner.

As illustrated in FIG. 2, the image forming unit 214 includes toner image forming units 215Y, 215M, 215C, and 215K (hereinafter denoted by 215Y to 215K), a transfer body 216, and a transfer member 217.

In the image forming unit 214, the toner image forming units 215Y to 215K perform charging, exposure, developing, and transfer processes to form toner images of respective colors, which are yellow (Y), magenta (M), cyan (C), and black (K), on the transfer body 216. The transfer member 217 transfers the toner images of the respective colors formed on the transfer body 216 to the medium P that passes through a transfer position TA between the transfer body 216 and the transfer member 217. As a result, an image is formed on the medium P. Thus, an example of the image forming apparatus may instead be an electrophotographic image forming apparatus.

An example of the image forming unit may instead be structured such that, for example, the toner image forming units 215Y to 215K form the toner images directly on the medium P instead of the transfer body 216.

### Heating Unit 19

The heating unit 19 illustrated in FIG. 1 is an example of a heating unit that heats the medium P on which an image is formed by the image forming unit 14. For example, the heating unit 19 heats the medium P by using a heating source (not illustrated) in a contactless manner to dry the image formed of ink.

An example of the heating unit is not limited to the above-described heating unit 19. An example of the heating unit may instead be, for example, a device that heats the medium P by coming into contact with the medium P without affecting the image. Various types of heating units may be used.

In the electrophotographic image forming apparatus including the image forming unit 214, the heating unit 19 functions, for example, as a fixing device that fixes the toner images by applying heat.

### Transport Mechanism 20

The transport mechanism 20 is a mechanism that transports the medium P. For example, the transport mechanism 20 transports the medium P by using a transport member 29 including, for example, transport rollers. The transport member 29 may instead be, for example, a transport belt. The transport member 29 may be any member capable of transporting the medium P by applying transporting force to the medium P.

The transport mechanism 20 transports the medium P from the medium storage unit 12 to the image forming unit 14 (more specifically, to the transfer position TA). The transport mechanism 20 further transports the medium P from the image forming unit 14 to the heating unit 19. The transport mechanism 20 further transports the medium P from the heating unit 19 to the medium output unit 13. The transport mechanism 20 also transports the medium P from the heating unit 19 to the image forming unit 14.

Thus, the image forming apparatus 10 includes a transport path 21 from the medium storage unit 12 to the image forming unit 14, a transport path 22 from the image forming unit 14 to the heating unit 19, and a transport path 23 from the heating unit 19 to the medium output unit 13. The image forming apparatus 10 also includes a transport path 24 from the heating unit 19 to the image forming unit 14.

The transport path 24 is a transport path along which the medium P having an image formed on one side thereof is returned to the image forming unit 14 (more specifically, to the transfer position TA). The transport path 24 also serves as a transport path that reverses the medium P having an image formed on one side thereof.

The transport path 21 and the transport path 24 include a common portion (more specifically, a downstream portion in the transporting direction). Accordingly, a transport path 25 along which the medium P is transported from the medium storage unit 12 may be regarded as being connected to the transport path 24 and configured to supply the medium P from the medium storage unit 12 to the transport path 24. Therefore, a position at which the transport path 25 is connected to the transport path 24 may be regarded as a supply position 25A at which a new medium P fed from the medium storage unit 12 is supplied to the transport path 24 and transported toward the image forming unit 14. In other words, according to the present exemplary embodiment, the medium P is supplied from the supply position 25A toward the image forming unit 14 through the transport path 24.

### Image Forming Operation of Image Forming Apparatus 10

In the image forming apparatus 10, the medium P is transported from the medium storage unit 12 to the image forming unit 14 (more specifically, to the transfer position TA) along the transport path 21, and the image forming unit 14 forms an image, which may hereinafter be referred to as “front image”, on one side (i.e., the front side) of the medium P. When an image is to be formed only on one side of the medium P, the medium P having the front image formed on one side thereof is transported through the heating unit 19 and output to the medium output unit 13.

When images are to be formed on both sides of the medium P, the medium P having the front image formed on one side thereof is transported through the heating unit 19 and then along the transport path 24, so that the medium P is reversed and returned to the image forming unit 14 (more specifically, to the transfer position TA). Then, the image forming unit 14 forms an image on the other side (i.e., the back side) of the medium P. After that, the medium P is transported through the heating unit 19 and output to the medium output unit 13. Thus, one and the other surfaces of the medium P are image forming surfaces on which images are formed.

### Position of Medium Storage Unit 12

As illustrated in FIG. 1, the medium storage unit 12 is disposed below the transport path 24. Therefore, each of the media P stored in the medium storage unit 12 is supplied to the supply position 25A of the transport path 24 from below.

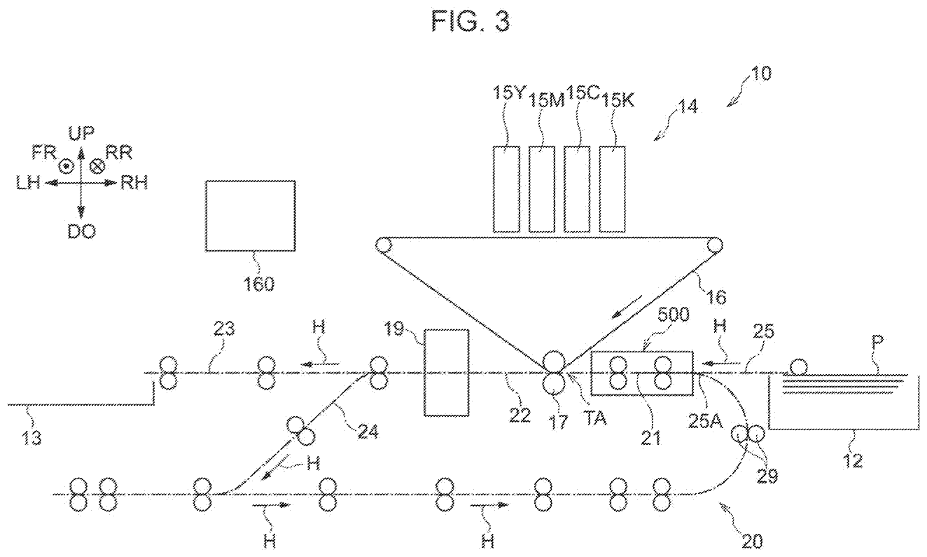

As illustrated in FIG. 3, the medium storage unit 12 may instead be disposed on a side of the transport path 24. In this case, each of the media P stored in the medium storage unit 12 is supplied to the supply position 25A of the transport path 24 in a sideways direction (from the right side in FIG. 3). In the structure illustrated in FIG. 3, the medium storage unit 12 is disposed on a side of the image forming unit 14 (more specifically, the transfer position TA). Accordingly, each medium P is supplied to the image forming unit 14 (more specifically, to the transfer position TA) in a sideways direction. In FIG. 3, the image forming apparatus body 11 is omitted.

### Detection Device 500

The detection device 500 illustrated in FIG. 1 is an example of a detection device that detects edge portions of the medium P. In FIG. 1, the detection device 500 is simplified.

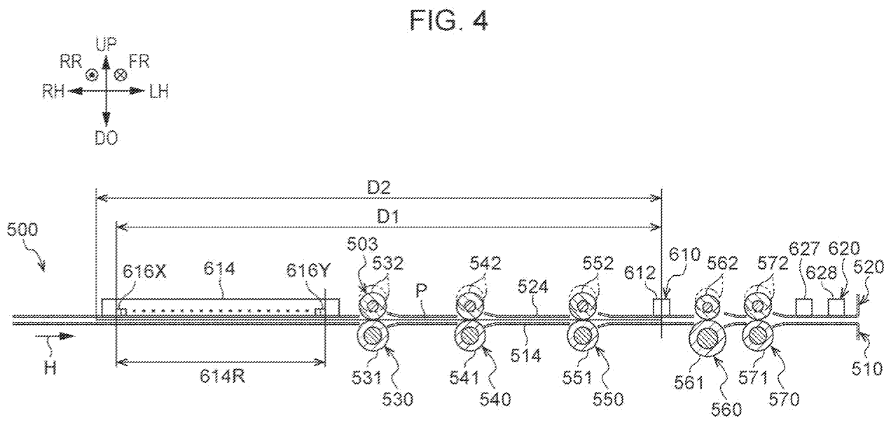

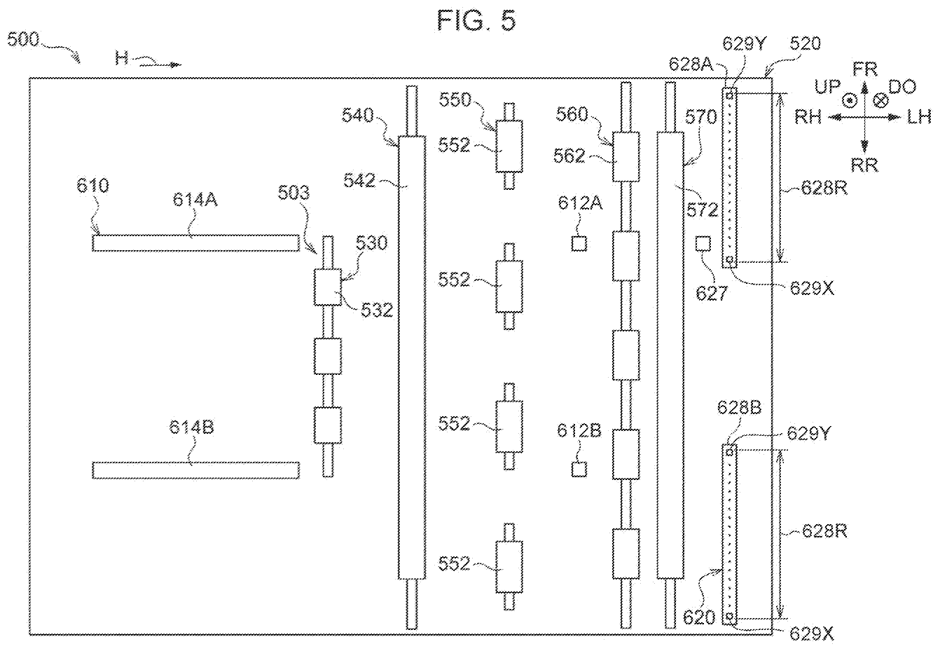

FIG. 4 is a side sectional view illustrating the structure of the detection device 500. FIG. 5 is a plan view illustrating the structure of the detection device 500. In FIGS. 4 to 6 and FIGS. 10 to 14, the left-right direction of the apparatus is reversed from that in FIGS. 1 to 3. More specifically, in FIGS. 4 to 6 and FIGS. 10 to 14, the left and right sides of the apparatus are opposite to the left and right sides of the figures.

With regard to the detection device 500, the expression “detect (or sense) an edge portion” does not necessarily mean that the edge of the medium P itself is directly detected (or sensed), and may also mean that a mark (for example, a trim mark) on the edge portion of the medium P, for example, is detected (or sensed). The mark is at a predetermined distance from the edge of the medium P so that the distance from the edge of the medium P is known.

As illustrated in FIG. 4, the detection device 500 includes a first support 510, a second support 520, a transport mechanism 503, detection units 610 and 620, and a leading edge sensor 627. The structures of components of the detection device 500 will now be described.

### First Support 510

The first support 510 illustrated in FIG. 4 has a function of supporting components (more specifically, driving rollers 531, 541, 551, 561, and 571 described below) of the transport mechanism 503.

As illustrated in FIG. 4, the first support 510 constitutes a lower portion of the detection device 500. The first support 510 has, for example, a flat shape that is thin in the up-down direction and extends in the front-rear and left-right directions.

The first support 510 includes a guide plate 514 that guides the medium P. The guide plate 514 faces the lower surface of the medium P and guides the medium P downstream in the transporting direction when the medium P is transported by the transport mechanism 503.

### Second Support 520

The second support 520 illustrated in FIGS. 4 and 5 has a function of supporting other components (more specifically, driven rollers 532, 542, 552, 562, and 572 described below) of the transport mechanism 503.

As illustrated in FIG. 4, the second support 520 constitutes an upper portion of the detection device 500. The second support 520 has, for example, a flat shape that is thin in the up-down direction and extends in the front-rear and left-right directions.

The second support 520 includes a guide plate 524 that guides the medium P. The guide plate 524 faces the upper surface of the medium P and guides the medium P downstream in the transporting direction when the medium P is transported by the transport mechanism 503.

### Transport Mechanism 503

The transport mechanism 503 illustrated in FIGS. 4 and 5 is a mechanism that transports the medium P in the detection device 500. As illustrated in FIGS. 4 and 5, the transport mechanism 503 includes transport roller units 530, 540, 550, 560, and 570. The transport roller units 530, 540, 550, 560, and 570 are arranged in that order toward the downstream side in the transporting direction. The transport roller units 530, 540, 550, 560, and 570 each have a function of transporting the medium P and include a pair of rollers, as illustrated in FIG. 4. More specifically, the transport roller units 530, 540, 550, 560, and 570 include the driving rollers 531, 541, 551, 561, and 571, respectively, and the driven rollers 532, 542, 552, 562, and 572, respectively.

The driving rollers 531, 541, 551, 561, and 571 are disposed below the driven rollers 532, 542, 552, 562, and 572, respectively, and are rotated to apply transporting force to the medium P.

The driven rollers 532, 542, 552, 562, and 572 are disposed above the driving rollers 531, 541, 551, 561, and 571, respectively, and are rotated by the rotations of the driving rollers 531, 541, 551, 561, and 571.

The driven rollers 532, 542, 552, 562, and 572 are supported by the second support 520 such that the driven rollers 532, 542, 552, 562, and 572 are movable between nipping positions (positions shown by the solid lines in FIG. 4) at which the medium P is nipped between the driven rollers 532, 542, 552, 562, and 572 and the driving rollers 531, 541, 551, 561, and 571 and separated positions (positions shown by the two-dot chain lines in FIG. 4) at which the driven rollers 532, 542, 552, 562, and 572 are separated from the medium P. The transport roller units 530, 540, 550, 560, and 570 transport the medium P while the driven rollers 532, 542, 552, 562, and 572 are at the nipping positions.

The transport roller unit 550 is an example of a transport unit and has a function of transporting the medium P to the transport roller unit 560.

The transport roller unit 560 is disposed downstream of the transport roller unit 550 in the transporting direction. The transport roller unit 560, which is an example of an abutting unit, is an abutting roller unit that abuts against the leading edge of the medium P. In the following description, the transport roller unit 560 may be referred to as an abutting roller unit 560. The abutting roller unit 560 has a function of correcting an inclination (i.e., skewing) of the medium P by abutting against the leading edge of the medium P transported by the transport roller unit 550.

The transport roller unit 570 is disposed downstream of the transport roller unit 560 in the transporting direction. The transport roller unit 570 is a correction roller unit that corrects a displacement of the medium P in the width direction. In the following description, the transport roller unit 570 may be referred to as a correction roller unit 570. The correction roller unit 570 corrects the displacement of the medium P in the width direction by moving in the width direction while nipping the medium P based on a detection result obtained by the detection unit 620. In the present exemplary embodiment, two roller units, which are the abutting roller unit 560 and the correction roller unit 570, serve a function of an adjustment unit that corrects skewing and displacement of the medium P. The medium P is transported to the image forming unit 14 (more specifically, the transfer position TA) after the position, for example, of the medium P is adjusted by the adjustment unit.

The transport roller units 530 and 540 are disposed upstream of the transport roller unit 550 in the transporting direction. The transport roller units 530 and 540 are examples of an upstream transport unit, and transport the medium P toward the transport roller unit 550.

In the present exemplary embodiment, the transport roller unit 550 transports the medium P at a constant transport speed that is lower than a transport speed at which the medium P is transported in a region upstream of leading edge sensors 612 (612A and 612B), which will be described below, in the transporting direction. More specifically, the transport roller unit 550 transports the medium P at a constant transport speed that is lower than a transport speed at which the medium P is transported in a region upstream of the transport roller unit 550 in the transporting direction.

Although the transport mechanism 503 includes the transport roller units 530, 540, 550, 560, and 570, the transport mechanism 503 is not limited to this. For example, the transport roller units 530, 540, 550, 560, and 570 may be replaced by transport members, such as transport belts. More specifically, an example of a transport unit and an example of an upstream transport unit are not limited to the transport roller units 530, 540, and 550, and transport members, such as transport belts, may instead be used. In addition, an example of the abutting unit is not limited to the abutting roller unit 560, and a transport member, such as a transport belt, may instead be used. The abutting unit may be any unit that abuts against the leading edge of the medium P transported from a region upstream of the transport roller unit 550 in the transporting direction.

### Detection Unit 610

The detection unit 610 illustrated in FIGS. 4 and 5 is an example of a first detection unit and has a function of detecting the leading and trailing edge portions of the medium P that is being transported. As illustrated in FIGS. 4 and 5, the detection unit 610 includes the leading edge sensors 612 (612A and 612B) and trailing edge sensors 614 (614A and 614B).

The leading edge sensors 612, which are examples of a leading edge sensing unit, sense the leading edge portion of the medium P that is being transported. More specifically, the leading edge sensors 612 are non-contact sensors that sense the leading edge portion of the medium P without coming into contact with the medium P. Still more specifically, the leading edge sensors 612 are optical sensors that use light emitted toward the medium P. Still more specifically, the leading edge sensors 612 are reflective optical sensors that sense the leading edge portion of the medium P by sensing light emitted toward and reflected by the medium P. The leading edge sensors 612 may instead be transmissive optical sensors.

The trailing edge sensors 614, which are examples of a trailing edge sensing unit, sense the trailing edge portion of the medium P that is being transported. As illustrated in FIG. 5, the leading edge sensors 612 and the trailing edge sensors 614 overlap when viewed in the transporting direction. More specifically, the leading edge sensors 612 and the trailing edge sensors 614 are arranged in the transporting direction (more specifically, left-right direction). Here, the expression “viewed in the transporting direction” means that the leading edge sensors 612 and the trailing edge sensors 614 are viewed in a direction from one of the upstream and downstream sides of the transporting direction toward the other side. In addition, the term “overlap” does not necessarily mean a complete overlap, and may instead be a partial overlap.

In the present exemplary embodiment, as illustrated in FIGS. 4 and 5, the detection unit 610 is disposed upstream of the abutting roller unit 560 in the transporting direction. More specifically, the leading edge sensors 612 are disposed upstream of the abutting roller unit 560 and downstream of the transport roller unit 550 in the transporting direction. The trailing edge sensors 614 are disposed upstream of the transport roller unit 530 in the transporting direction.

The trailing edge sensors 614 are non-contact sensors that sense the trailing edge portion of the medium P without coming into contact with the medium P. More specifically, the trailing edge sensors 614 are optical sensors that use light emitted toward the medium P. Still more specifically, as illustrated in FIG. 4, the trailing edge sensors 614 are line sensors which each extend in the transporting direction and include plural sensing elements 616 (more specifically, light emitting elements and light receiving elements) arranged in the transporting direction. Still more specifically, the trailing edge sensors 614 are, for example, contact image sensors (CISs). The trailing edge sensors 614 may instead be line sensors other than contact image sensors.

The trailing edge sensors 614 each have a detection region 614R that extends from a sensing element 616X disposed most upstream in the transporting direction to a sensing element 616Y disposed most downstream in the transporting direction and in which the trailing edge portion of the medium P is sensed.

Each trailing edge sensor 614 determines the position of the trailing edge portion of the medium P based on a boundary between the sensing elements 616 in a sensing state and the sensing elements 616 in a non-sensing state in the detection region 614R. Position information represented by the coordinate of the determined position (more specifically, the number of pixels counted from the downstream end of the detection region 614R in the transporting direction) is transmitted to, for example, the control device 160.

Referring to FIG. 4, the detection unit 610 is structured such that a distance D1 between the sensing element 616X disposed most upstream in the transporting direction in each trailing edge sensor 614 and the corresponding leading edge sensor 612 is less than a transporting-direction dimension D2 of the medium P having the maximum size. In other words, when the leading edge portion of the medium P having the maximum size is sensed by the leading edge sensor 612, the trailing edge portion of the medium P projects upstream from the detection region 614R in the transporting direction. The detection region 614R is disposed so that the trailing edge portion of the medium P enters the detection region 614R before the leading edge portion of the medium P having the maximum size reaches the abutting roller unit 560 that is downstream of the leading edge sensor 612 in the transporting direction.

In the present exemplary embodiment, two pairs of leading and trailing edge sensors 612 and 614 are provided, as indicated by the letters A and B added to the reference numerals thereof in FIG. 5. More specifically, the pairs of leading and trailing edge sensors 612 and 614 are disposed in front and rear regions of the detection device 500.

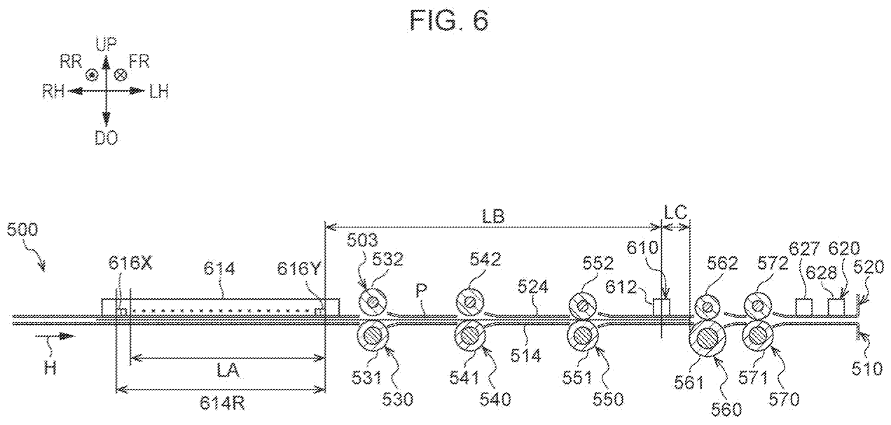

As illustrated in FIG. 6, in the detection unit 610, the leading and trailing edge sensors 612 and 614 sense the leading and trailing edge portions of the medium P that is being transported by the transport roller unit 550 while the driven rollers 532 and 542 of the transport roller units 530 and 540 are at the separated positions.

Although the detection unit 610, which is an example of a first detection unit, may have the above-described structure, the structure of an example of a first detection unit is not limited to this. For example, an example of a first detection unit may instead include one pair of leading and trailing edge sensors 612 and 614. In addition, an example of a first detection unit may instead be structured such that the leading and trailing edge sensors 612 and 614 are displaced from each other in the width direction. An example of a first detection unit may be any unit that detects the leading and trailing edge portions of the medium P that is being transported.

### Leading Edge Sensor 627

The leading edge sensor 627 illustrated in FIGS. 4 and 5 has a function of sensing the leading edge portion of the medium P detected by the detection unit 610 while the medium P is being transported. More specifically, the leading edge sensor 627 is disposed downstream of the correction roller unit 570 in the transporting direction.

The leading edge sensor 627 senses the leading edge portion of the medium P that is being transported by the correction roller unit 570 while the driven rollers 532, 542, 552, and 562 of the transport roller units 530, 540, and 550 and the abutting roller unit 560 are at the separated positions.

More specifically, the leading edge sensor 627 is a non-contact sensor that senses the leading edge portion of the medium P without coming into contact with the medium P. Still more specifically, the leading edge sensor 627 is an optical sensor that uses light emitted toward the medium P. Still more specifically, the leading edge sensor 627 is a reflective optical sensor that senses the leading edge portion of the medium P by sensing light emitted toward and reflected by the medium P. The leading edge sensor 627 may instead be a transmissive optical sensor.

### Detection Unit 620

The detection unit 620 illustrated in FIGS. 4 and 5 is an example of a second detection unit and has a function of detecting both edge portions in the width direction (i.e., a pair of side edge portions) of the medium P detected by the detection unit 610 while the medium P is being transported. As illustrated in FIG. 5, the detection unit 620 includes a pair of side edge sensors 628 (628A and 628B).

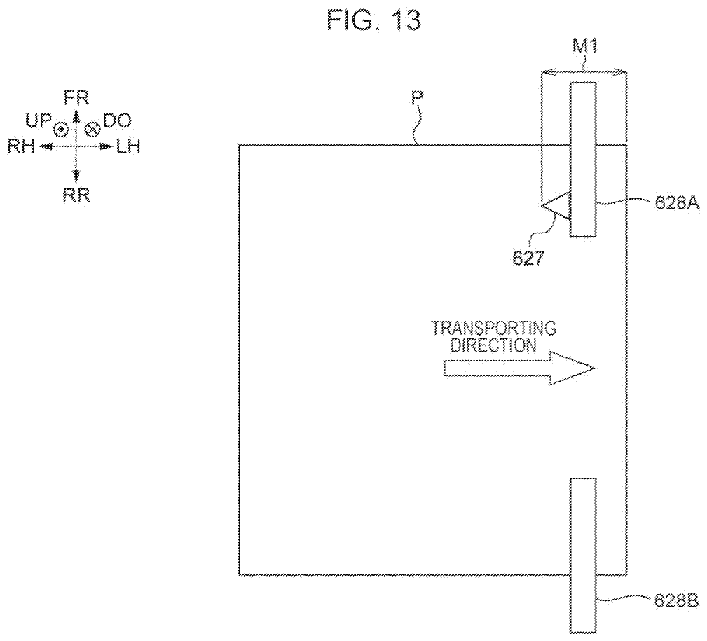

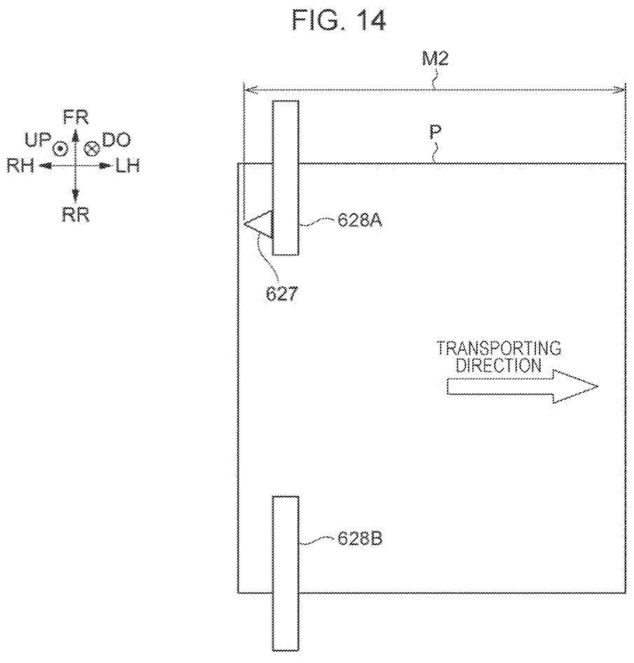

The pair of side edge sensors 628 detect one and the other edge portions of the medium P in the width direction. In addition, the pair of side edge sensors 628 are positioned to face each other in the width direction (see FIGS. 13 and 14). Thus, the detection unit 620 is divided into a section that detects one edge portion of the medium P in the width direction and a section that detects the other edge portion of the medium P in the width direction, and these sections are disposed to face each other in the width direction.

In the present exemplary embodiment, as illustrated in FIG. 5, the pair of side edge sensors 628 include a side edge sensor 628A disposed adjacent to the front of the apparatus and a side edge sensor 628B disposed adjacent to the rear of the apparatus, and sense the pair of side edge portions of the medium P that is being transported. The pair of side edge sensors 628 overlap when viewed in the width direction. More specifically, the pair of side edge sensors 628 are arranged in the width direction (more specifically, the front-rear direction).

In the present exemplary embodiment, the detection unit 620 is disposed downstream of the abutting roller unit 560 in the transporting direction. More specifically, the detection unit 620 is disposed downstream of the leading edge sensor 627 in the transporting direction.

The pair of side edge sensors 628 are non-contact sensors that sense the pair of side edge portions of the medium P without coming into contact with the medium P. More specifically, the pair of side edge sensors 628 are optical sensors that use light emitted toward the medium P. Still more specifically, as illustrated in FIG. 5, the pair of side edge sensors 628 are line sensors which each extend in the width direction and include plural sensing elements 629 (more specifically, light emitting elements and light receiving elements) arranged in the width direction. Still more specifically, the pair of side edge sensors 628 are, for example, contact image sensors (CISs). The pair of side edge sensors 628 may instead be line sensors other than contact image sensors.

The pair of side edge sensors 628 each have a detection region 628R that extends from a sensing element 629X at one end in the width direction to a sensing element 629Y at the other end in the width direction and in which a side edge portion of the medium P is sensed.

Each of the pair of side edge sensors 628 determines the position of the corresponding side edge portion of the medium P based on a boundary between the sensing elements 629 in a sensing state and the sensing elements 629 in a non-sensing state in the detection region 628R. Position information represented by the coordinate of the determined position (more specifically, the number of pixels counted from the front end of the detection region 628R) is transmitted to, for example, the control device 160.

The pair of side edge sensors 628 of the detection unit 620 sense the pair of side edge portions of the medium P that is being transported by the correction roller unit 570 while the driven rollers 532, 542, 552, and 562 of the transport roller units 530, 540, and 550 and the abutting roller unit 560 are at the separated positions.

Although the detection unit 620, which is an example of a second detection unit, may have the above-described structure, the structure of an example of a second detection unit is not limited to this. For example, plural pairs of side edge sensors 628 may be provided. In addition, an example of a second detection unit may instead be structured such that the pair of side edge sensors 628 are displaced from each other in the transporting direction. In addition, although an example of a second detection unit is disposed downstream of the first detection unit in the transporting direction, an example of a second detection unit may instead be disposed upstream of the detection unit 610 in the transporting direction. an example of a second detection unit may be any unit that detects both edge portions of the medium P detected by the detection unit 610 in an orthogonal direction that is orthogonal to the transporting direction while the medium P is being transported.

### Control Device 160

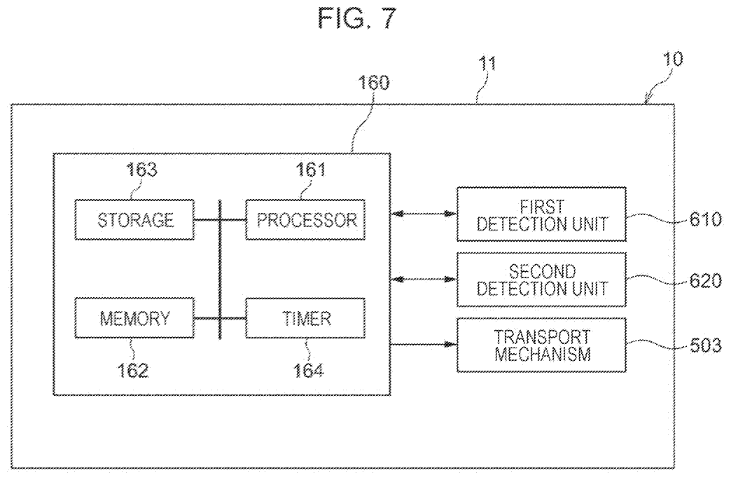

The structure of the control device 160 will now be described. The control device 160 has a function of controlling the operations of components of the image forming apparatus 10 including components of the detection device 500. The control device 160 also has a function of determining the length of the medium P based on the detection results obtained by the detection units 610 and 620. More specifically, as illustrated in FIG. 7, the control device 160 includes a processor 161, a memory 162, a storage 163, and a timer 164.

The term “processor” refers to hardware in a broad sense. Examples of the processor 161 include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

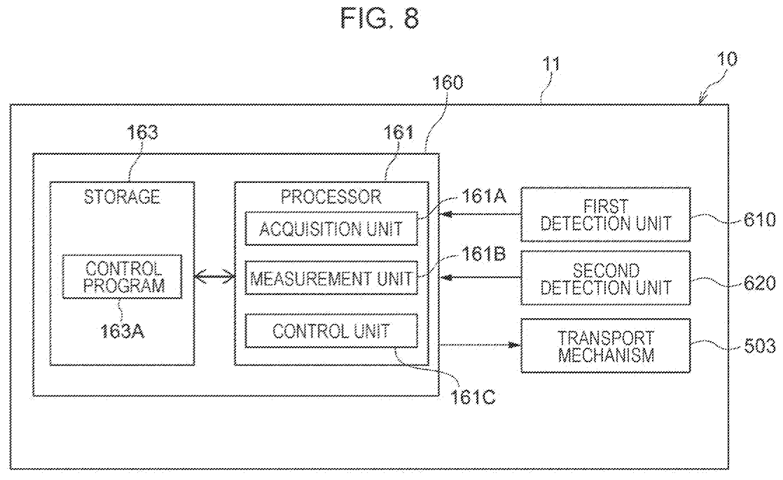

The storage 163 stores various programs including a control program 163A (see FIG. 8) and various data. The storage 163 may be realized as a recording device, such as a hard disk drive (HDD), a solid state drive (SSD), or a flash memory.

The memory 162 is a work area that enables the processor 161 to execute various programs, and temporarily stores various programs or various data when the processor 161 performs a process. The processor 161 reads various programs including the control program 163A into the memory 162 from the storage 163, and executes the programs by using the memory 162 as a work area. The timer 164 is a measurement unit used to measure elapsed times X and Y described below.

In the control device 160, the processor 161 executes the control program 163A to realize various functions. A functional configuration realized by cooperation of the processor 161, which serves as a hardware resource, and the control program 163A, which serves as a software resource, will now be described. FIG. 8 is a block diagram illustrating the functional configuration of the processor 161.

As illustrated in FIG. 8, in the control device 160, the processor 161 executes the control program 163A to function as the acquisition unit 161A, the measurement unit 161B, and the control unit 161C.

The control unit 161C controls the transport mechanism 503, the detection units 610 and 620, and the leading edge sensor 627 to execute a detection operation described below.

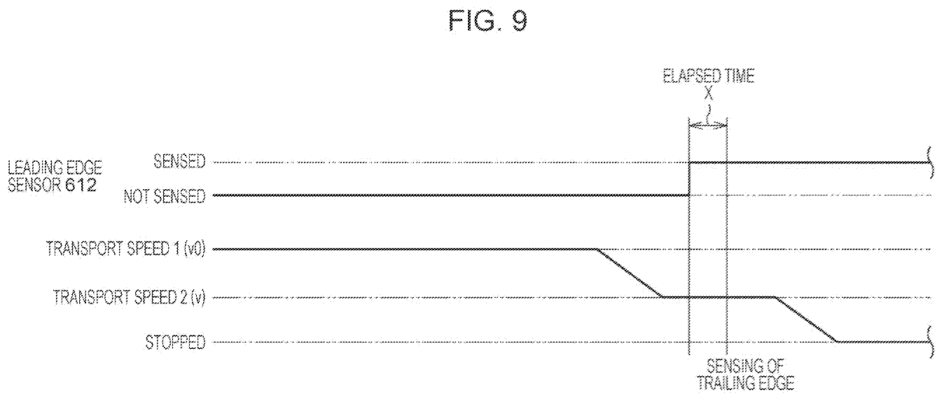

As illustrated in FIG. 9, for example, the transport roller units 530 and 540 of the transport mechanism 503 transport the medium P at a predetermined transport speed 1, and further transport the medium P while reducing the transport speed to a transport speed 2 that is lower than the transport speed 1. Then, for example, the transport roller unit 550 of the transport mechanism 503 receives the medium P from the transport roller units 530 and 540 and transports the medium P while maintaining the transport speed constant at the transport speed 2. When the transport roller unit 550 transports the medium P, the driven rollers 532 and 542 of the transport roller units 530 and 540 are moved to the separated positions. In other words, the transport roller unit 550 alone transports the medium P toward the abutting roller unit 560 while maintaining the transport speed constant at the transport speed 2 (see FIG. 6). The constant speed is not necessarily strictly constant as long as the speed is substantially constant.

The leading edge sensors 612 of the detection unit 610 sense the leading edge portion of the medium P transported by the transport roller unit 550. After a predetermined time (hereinafter referred to as an elapsed time X) from the sensing of the leading edge portion, the trailing edge sensors 614 sense the trailing edge portion of the medium P. At this time, the leading edge of the medium P is positioned upstream of the abutting roller unit 560 in the transporting direction (see FIG. 6). In other words, the trailing edge portion is sensed before the leading edge of the medium P abuts against the abutting roller unit 560. The leading edge sensors 612 and the trailing edge sensors 614 respectively sense the leading and trailing edge portions of the medium P while the transport roller unit 550 alone transports the medium P.

When the medium P has the maximum size, the trailing edge portion is positioned upstream of the detection region 614R of each trailing edge sensor 614 in the transporting direction (see FIG. 5) at the time of sensing of the leading edge portion by each leading edge sensor 612. Then, after the predetermined elapsed time X, the trailing edge portion is positioned in the detection region 614R of each trailing edge sensor 614 (see FIG. 6). When the medium P has the minimum size, the trailing edge portion is positioned in the detection region 614R of each trailing edge sensor 614 both at the time of sensing of the leading edge portion by each leading edge sensor 612 and the time after the predetermined elapsed time X.

The transport roller unit 550 continues to transport the medium P for a predetermined time period from when the medium P abuts against the abutting roller unit 560, so that the leading edge of the medium P abuts against the abutting roller unit 560 from one end to the other end thereof in the width direction. Then, the transport roller unit 550 stops transporting the medium P.

After that, the abutting roller unit 560 transports the medium P. When the abutting roller unit 560 transports the medium P, the driven rollers 532, 542, and 552 of the transport roller units 530, 540, and 550 are moved to the separated positions. Accordingly, the abutting roller unit 560 alone transports the medium P toward the correction roller unit 570.

After that, the correction roller unit 570 transports the medium P. When the correction roller unit 570 transports the medium P, the driven rollers 532, 542, 552, and 562 of the transport roller units 530, 540, and 550 and the abutting roller unit 560 are moved to the separated positions. Accordingly, the correction roller unit 570 alone transports the medium P downstream in the transporting direction.

The leading edge sensor 627 of the detection unit 620 senses the leading edge portion of the medium P transported by the correction roller unit 570. After a predetermined time (hereinafter referred to as an elapsed time Y) from the sensing of the leading edge portion, the pair of side edge sensors 628 sense the pair of side edge portions of the medium P. The leading edge sensor 627 and the pair of side edge sensors 628 sense the leading edge portion and the pair of side edge portions of the medium P while the correction roller unit 570 alone transports the medium P.

The correction roller unit 570 moves in the width direction based on an amount of displacement (described below) detected by the detection unit 620 to correct the displacement of the medium P in the width direction.

When the image forming unit 214 is used as an image forming unit, the abutting roller unit 560 starts to transport the medium P again so that the time at which the toner image formed on the transfer body 216 reaches the transfer position TA is synchronized with the time at which the medium P reaches the transfer position TA.

The acquisition unit 161A acquires detection information obtained by the detection units 610 and 620 that detect the leading and trailing edge portions and the pair of side edge portions of the medium P. The detection information of the trailing edge portion and the pair of side edge portions includes position information representing the positions of the trailing edge portion and the pair of side edge portions of the medium P. More specifically, the position information of the trailing edge portion of the medium P represents a position in the transporting direction, and the position information of the side edge portions of the medium P represents positions in the width direction of the medium P.

More specifically, for example, each trailing edge sensor 614 determines the position of the trailing edge portion of the medium P based on the boundary between the sensing elements 616 in a sensing state and the sensing elements 616 in a non-sensing state in the detection region 614R thereof. Then, the acquisition unit 161A acquires position information represented by the coordinate of the determined position (more specifically, the number of pixels counted from the downstream end of the detection region 614R in the transporting direction).

In addition, for example, each of the pair of side edge sensors 628 determines the position of the corresponding side edge portion of the medium P based on the boundary between the sensing elements 629 in a sensing state and the sensing elements 629 in a non-sensing state in the detection region 628R thereof. Then, the acquisition unit 161A acquires position information represented by the coordinate of the determined position (more specifically, the number of pixels counted from the front end of the detection region 628R).

The measurement unit 161B determines the transporting-direction dimension of the medium P based on the position information acquired by the acquisition unit 161A, for example, as follows.

For example, the measurement unit 161B determines a distance LA (see FIG. 6) from the downstream end of the detection region 614R of each trailing edge sensor 614 in the transporting direction (i.e., the sensing element 616Y disposed most downstream in the transporting direction) to the trailing edge of the medium P based on the position information.

More specifically, the distance LA is determined from Equation (1) given below based on the overall number of pixels P1 (pixels/mm) in the sensing elements 616 of each trailing edge sensor 614 and the number of pixels P2 (pixels) in a range from the downstream end of the detection region 614R of the trailing edge sensor 614 in the transporting direction to the trailing edge of the medium P.

LA=P2÷P1 Equation (1)

A distance LB (see FIG. 6) from the downstream end of the detection region 614R of each trailing edge sensor 614 in the transporting direction to each leading edge sensor 612 is known. A distance LC (see FIG. 6) from each leading edge sensor 612 to the leading edge of the medium P may be determined in advance as a known value by multiplying the transport speed 2, which is known, by the elapsed time X, which is also known. The measurement unit 161B determines the transporting-direction dimension L1 of the medium P from Equation (2) given below.

L1=LA+LB+LC Equation (2)

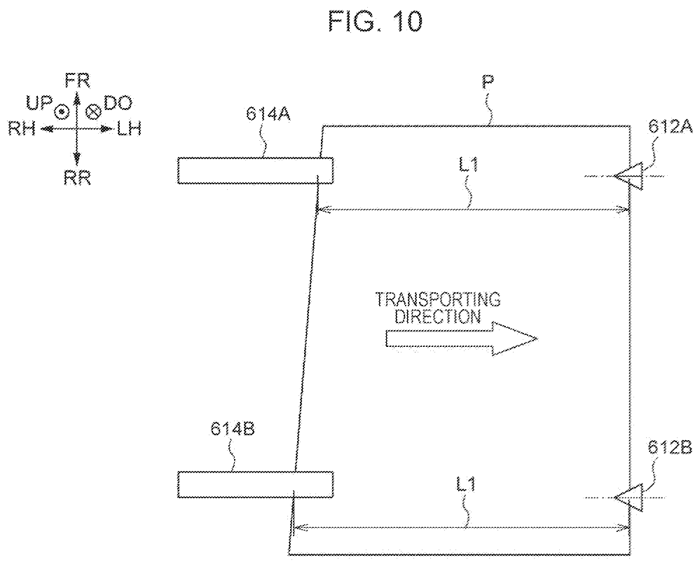

In the present exemplary embodiment, as illustrated in FIG. 10, the transporting-direction dimension L1 is measured at one and the other sides of the medium P in the width direction based on the sensing results obtained by the two leading edge sensors 612A and 612B and the two trailing edge sensors 614A and 614B. In FIGS. 10 to 12, the two leading edge sensors 612A and 612B and the two trailing edge sensors 614A and 614B are illustrated schematically.

When, for example, the medium P is a paper sheet, the transporting-direction dimension L1 at one side of the medium P in the width direction may differ from that at the other side due to a cutting error, as illustrated in FIG. 10. This cutting error may be determined. The transporting-direction dimension of the medium P may be determined as, for example, the average, minimum, or maximum value of the transporting-direction dimensions L1 at one and the other sides of the medium P in the width direction.

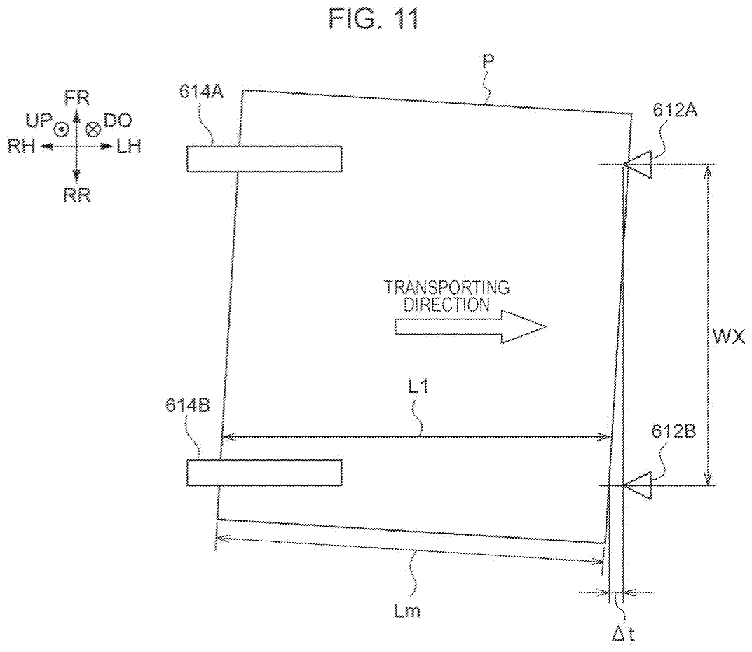

Referring to FIG. 11, in the present exemplary embodiment, skewing of the medium P may be detected based on the difference between the sensing times of the two leading edge sensors 612A and 612B. When the medium P is skewed, there may be an error between the calculated transporting-direction dimension L1 and the actual transporting-direction dimension Lm.

The above-described error may be corrected by determining the amount of skewing based on the transport speed 2 (v) of the medium P, the difference Δt between the times at which the medium P passes the leading edge sensors 612A and 612B, and a distance WX between the leading edge sensors 612A and 612B, and determining the actual transporting-direction dimension Lm from Equation (3) given below.

Lm=(√((Δt÷v)²+WX²)÷WX)×L1 Equation (3)

The measurement unit 161B determines the width-direction dimension W1 of the medium P based on the position information acquired by the acquisition unit 161A, for example, as follows.

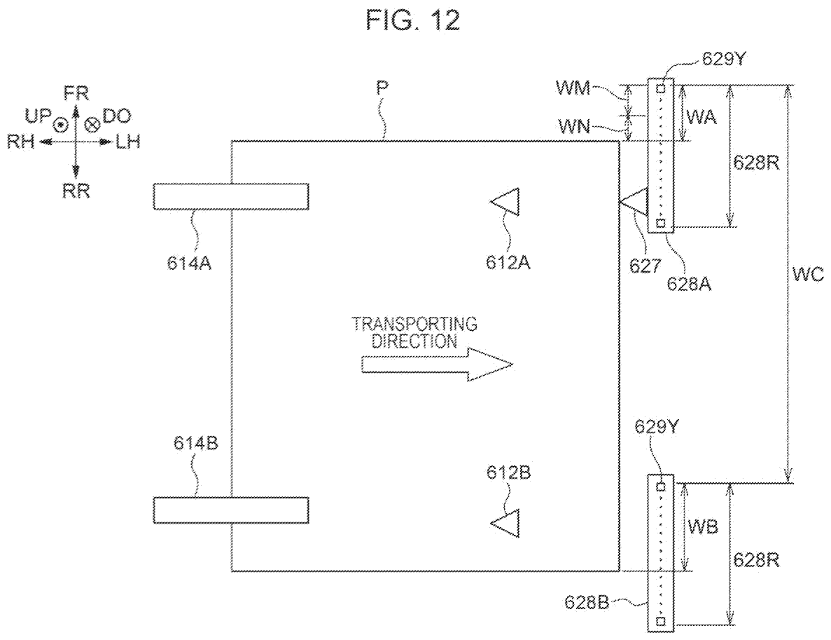

For example, the measurement unit 161B determines a distance WA (see FIG. 12) from the front end of the detection region 628R of the side edge sensor 628A (i.e., the sensing element 629Y disposed at the front end) to one side edge of the medium P (more specifically, the side edge adjacent to the front of the apparatus) based on the position information.

More specifically, the distance WA is determined from Equation (4) given below based on the overall number of pixels P3 (pixels/mm) in the sensing elements 629 of the side edge sensor 628A and the number of pixels P4 (pixels) in a range from the front end of the detection region 628R of the side edge sensor 628A to one side edge (more specifically, the side edge adjacent to the front of the apparatus).

WA=P4÷P3 Equation (4)

In addition, for example, the measurement unit 161B determines a distance WB (see FIG. 12) from the front end of the detection region 628R of the side edge sensor 628B (i.e., the sensing element 629Y disposed at the front end) to the other side edge of the medium P (more specifically, the side edge adjacent to the rear of the apparatus) based on the position information.

More specifically, the distance WB is determined from Equation (5) given below based on the overall number of pixels P5 (pixels/mm) in the sensing elements 629 of the side edge sensor 628B and the number of pixels P6 (pixels) in a range from the front end of the detection region 628R of the side edge sensor 628B to the other side edge (more specifically, the side edge adjacent to the rear of the apparatus).

WB=P6÷P5 Equation (5)

A distance WC from the front end of the detection region 614R of the side edge sensor 628A to the front end of the detection region 614R of the side edge sensor 628B is known. The measurement unit 161B determines the width-direction dimension W1 of the medium P from Equation (6) given below.

W1=WC+WB−WA Equation (6)

In addition, for example, the measurement unit 161B determines the amount of displacement of the medium P in the width direction based on the position information acquired by the acquisition unit 161A as follows.

For example, as described above, the measurement unit 161B determines the distance WA (see FIG. 12) from the front end of the detection region 628R of the side edge sensor 628A (i.e., the sensing element 629Y disposed at the front end) to one side edge of the medium P (more specifically, the side edge adjacent to the front of the apparatus) based on the position information.

A distance WM (see FIG. 12) from the front end of the detection region 628R of the side edge sensor 628A (i.e., the sensing element 629Y disposed at the front end) to one side edge of the medium P (more specifically, the side edge adjacent to the front of the apparatus) when the medium P is disposed at a reference position is determined in advance as a known value.

The reference position of the medium P is a position in the width direction set in advance as a position at which the medium P is to be located when the medium P is transported.

The measurement unit 161B determines the amount of displacement WN of the medium P in the width direction based on the difference between the distance WM and the distance WA. Thus, the amount of displacement of the medium P in the width direction is determined based on the detection result obtained by one side edge sensor 628A, which is an example of one of the sections into which the detection unit 620 is divided.

The measurement unit 161B may instead determine the amount of displacement of the medium P in the width direction based on the distance WB from the front end of the detection region 628R of the side edge sensor 628B (i.e., the sensing element 629Y disposed at the front end) to the other side edge of the medium P (more specifically, the side edge adjacent to the rear of the apparatus). The amount of displacement of the medium P in the width direction may instead be determined based on both the distance WA and the distance WB.

In the present exemplary embodiment, the pair of side edge sensors 628 may sense the pair of side edge portions at the downstream side of the medium P in the transporting direction (see FIG. 13) and at the upstream side of the medium P in the transporting direction (see FIG. 14). The sensing results may be used to determine the width-direction dimension W1 at the upstream and downstream sides of the medium P in the transporting direction.

More specifically, for example, the pair of side edge sensors 628 sense the pair of side edge portions of the medium P after the elapsed time Y from when the leading edge portion of the medium P transported by the correction roller unit 570 is sensed by the leading edge sensor 627 of the detection unit 620. Accordingly, as illustrated in FIG. 13, the pair of side edge portions are sensed at the downstream side of the medium P in the transporting direction.

In the example illustrated in FIG. 13, the pair of side edge portions of the medium P are sensed after the leading edge portion of the medium P has been transported from the leading edge sensor 627 by a distance M1 obtained by multiplying the transport speed of the correction roller unit 570 by the elapsed time Y.

In addition, the pair of side edge sensors 628 sense the pair of side edge portions of the medium P after an elapsed time Z, which is longer than the elapsed time Y, from when the leading edge portion of the medium P transported by the correction roller unit 570 is sensed by the leading edge sensor 627 of the detection unit 620. Accordingly, as illustrated in FIG. 14, the pair of side edge portions are sensed at the upstream side of the medium P in the transporting direction.

In the example illustrated in FIG. 14, the pair of side edge portions of the medium P are sensed after the leading edge portion of the medium P has been transported from the leading edge sensor 627 by a distance M2 obtained by multiplying the transport speed of the correction roller unit 570 by the elapsed time Z. The distance M2 is longer than the distance M1.

When, for example, the medium P is a paper sheet, the width-direction dimension W1 at the upstream side of the medium P in the transporting direction may differ from that at the downstream side due to a cutting error. This cutting error may be measured. The width-direction dimension of the medium P may be determined as, for example, the average, minimum, or maximum value of the width-direction dimensions W1 at the upstream and downstream sides of the medium P in the transporting direction.

In addition, in the present exemplary embodiment, an error between the calculated width-direction dimension W1 and an actual width-direction dimension caused by skewing of the medium P may be corrected based on the sensing results obtained by the pair of side edge sensors 628 that sense the pair of side edge portions at the downstream side of the medium P in the transporting direction (see FIG. 13) and at the upstream side of the medium P in the transporting direction (see FIG. 14).

In FIGS. 12 to 14, the leading edge sensor 627 and the pair of side edge sensors 628 are illustrated schematically.

### Operations of Present Exemplary Embodiment

In the present exemplary embodiment, the detection unit 620 detects both edge portions (pair of side edge portions) of the medium P detected by the detection unit 610 in the width direction while the medium P is being transported.

In the present exemplary embodiment, as illustrated in FIGS. 4 and 5, the detection unit 620 is disposed downstream of the abutting roller unit 560 in the transporting direction. Therefore, the detection unit 620 is capable of detecting the pair of side edge portions of the medium P after the medium P is abutted against the abutting roller unit 560 so that the position thereof is adjusted.

In the present exemplary embodiment, the detection unit 620 is divided into a section that detects one edge portion of the medium P in the width direction and a section that detects the other edge portion of the medium P in the width direction, and these sections are disposed to face each other in the width direction.

In the present exemplary embodiment, the side edge sensor 628A, which is an example of one of the sections into which the detection unit 620 is divided, detects the amount of displacement of the medium P in the width direction.

In the present exemplary embodiment, as illustrated in FIGS. 4 and 5, the detection unit 610 is disposed upstream of the abutting roller unit 560 in the transporting direction.

A configuration in which the detection unit 610 is disposed downstream of the abutting roller unit 560 in the transporting direction is hereinafter referred to as configuration A. In configuration A, since the detection unit 610, which is long in the transporting direction, is disposed downstream of the abutting roller unit 560 in the transporting direction, the abutting roller unit 560 is disposed in an upstream region of the transport passage along which the medium P is transported through the detection device 500 in the transporting direction. As a result, the distance between the transfer position TA and the abutting roller unit 560 is increased, and skewing of the medium P may recur after the medium P has been abutted against the abutting roller unit 560 to adjust the position thereof.

In contrast, in the present exemplary embodiment, the detection unit 610 is disposed upstream of the abutting roller unit 560 in the transporting direction. Therefore, the abutting roller unit 560 is disposed closer to the downstream end of the transport passage along which the medium P is transported through the detection device 500 in the transporting direction. As a result, the distance between the transfer position TA and the abutting roller unit 560 is reduced.

In addition, in the present exemplary embodiment, as illustrated in FIGS. 4 and 5, the detection unit 610 is disposed upstream of the correction roller unit 570 in the transporting direction.

A configuration in which the detection unit 610 is disposed downstream of the correction roller unit 570 in the transporting direction is hereinafter referred to as configuration X. In configuration X, since the detection unit 610, which is long in the transporting direction, is disposed downstream of the correction roller unit 570 in the transporting direction, the correction roller unit 570 is disposed in an upstream region of the transport passage along which the medium P is transported through the detection device 500 in the transporting direction. As a result, the distance between the transfer position TA and the correction roller unit 570 is increased, and the displacement of the medium P may recur after the displacement has been corrected by the correction roller unit 570.

In contrast, in the present exemplary embodiment, the detection unit 610 is disposed upstream of the correction roller unit 570 in the transporting direction. Therefore, the correction roller unit 570 is disposed closer to the downstream end of the transport passage along which the medium P is transported through the detection device 500 in the transporting direction. As a result, the distance between the transfer position TA and the correction roller unit 570 is reduced.

In the present exemplary embodiment, as illustrated in FIG. 4, the distance D1 between the sensing element 616X disposed most upstream in the transporting direction in each trailing edge sensor 614 and the corresponding leading edge sensor 612 is less than the transporting-direction dimension D2 of the medium P having the maximum size.

In the present exemplary embodiment, two pairs of leading and trailing edge sensors 612 and 614 that overlap when viewed in the transporting direction are provided, as indicated by the letters A and B added to the reference numerals thereof in FIG. 5.

In addition, in the present exemplary embodiment, as illustrated in FIG. 6, the leading and trailing edge sensors 612 and 614 respectively sense the leading and trailing edge portions of the medium P while the medium P is being transported by the transport roller 550 that transports the medium P at a constant transport speed that is lower than a transport speed at which the medium P is transported in a region upstream of the leading edge sensors 612 in the transporting direction.

A configuration in which the leading and trailing edge sensors 612 and 614 sense the leading and trailing edge portions of the medium P while the medium P is being transported by a transport unit that transports the medium P at a gradually decreasing transport speed is hereinafter referred to as configuration B. The transport speed gradually decreases from the transport speed at which the medium P is transported in the region upstream of the leading edge sensors 612 in the transporting direction. In configuration B, the leading and trailing edge portions of the medium P are sensed while the transport speed of the medium P varies.

In the present exemplary embodiment, as illustrated in FIG. 6, the leading and trailing edge sensors 612 and 614 sense the leading and trailing edge portions of the medium P while the driven rollers 532 and 542 of the transport roller units 530 and 540 are at the separated positions.

### Modifications

In the present exemplary embodiment, as illustrated in FIGS. 4 and 5, the detection unit 620 is disposed downstream of the abutting roller unit 560 in the transporting direction. However, the detection unit 620 is not limited to this. For example, the detection unit 620 may instead be disposed upstream of the abutting roller unit 560 in the transporting direction.

In the present exemplary embodiment, the detection unit 620 is divided into a section that detects one edge portion of the medium P in the width direction and a section that detects the other edge portion of the medium P in the width direction, and these sections are disposed to face each other in the width direction. However, the detection unit 620 is not limited to this. For example, the detection unit 620 may be composed of a single detection unit that extends from one edge portion to the other edge portion of the medium P in the width direction and is not divided.

In the present exemplary embodiment, the side edge sensor 628A, which is an example of one of the sections into which the detection unit 620 is divided, detects the amount of displacement of the medium P in the width direction. However, the detection unit 620 is not limited to this. For example, a detection unit that detects the amount of displacement of the medium P in the width direction may be provided in addition to the detection unit 620.

In the present exemplary embodiment, as illustrated in FIGS. 4 and 5, the detection unit 610 is disposed upstream of the abutting roller unit 560 in the transporting direction. However, the detection unit 610 is not limited to this. The detection unit 610 may instead be disposed downstream of the abutting roller unit 560 in the transporting direction.

In the present exemplary embodiment, as illustrated in FIG. 4, the distance D1 between the sensing element 616X disposed most upstream in the transporting direction in each trailing edge sensor 614 and the corresponding leading edge sensor 612 is less than the transporting-direction dimension D2 of the medium P having the maximum size. However, the distance D1 is not limited to this. The distance D1 may instead be longer than the transporting-direction dimension D2 of the medium P having the maximum size.

In the present exemplary embodiment, as illustrated in FIG. 6, the leading and trailing edge sensors 612 and 614 respectively sense the leading and trailing edge portions of the medium P while the medium P is being transported by the transport roller 550 that transports the medium P at a constant transport speed that is lower than a transport speed at which the medium P is transported in a region upstream of the leading edge sensors 612. However, the leading and trailing edge sensors 612 and 614 are not limited to this. For example, the leading and trailing edge sensors 612 and 614 may instead sense the leading and trailing edge portions of the medium P while the medium P is being transported by a transport unit that transports the medium P at a transport speed that gradually decreases from the transport speed at which the medium P is transported in the region upstream of the leading edge sensors 612 in the transporting direction. In addition, it is not necessary that the transport speed of the medium P be constant as long as at least the deceleration of the medium P at and during the detection of the leading and trailing edge portions of the medium P by the detection unit 610 is less than the deceleration of the medium P before and after the detection of the leading and trailing edge portions of the medium P by the detection unit 610.

In the present exemplary embodiment, as illustrated in FIG. 6, the leading and trailing edge sensors 612 and 614 sense the leading and trailing edge portions of the medium P while the driven rollers 532 and 542 of the transport roller units 530 and 540 are at the separated positions. However, the leading and trailing edge sensors 612 and 614 are not limited to this. For example, the leading and trailing edge sensors 612 and 614 may instead sense the leading and trailing edge portions of the medium P while the driven rollers 532 and 542 of the transport roller units 530 and 540 are at the nipping positions.

The present disclosure is not limited to the above-described exemplary embodiment, and various modifications, alterations, and improvements are possible without departing from the spirit of the present disclosure. For example, the above-described modifications may be applied in combinations with each other as appropriate.

In the embodiments above, the term “processor” is broad enough to encompass one processor or plural processors in collaboration which are located physically apart from each other but may work cooperatively. The order of operations of the processor is not limited to one described in the embodiments above, and may be changed.

The programs used in the above embodiments may be provided in a state such that they are stored in a computer readable storage medium. Examples of the computer readable storage medium include magnetic storage media (e.g., magnetic tape, magnetic disks (HDD: Hard Disk Drive, FDD: Flexible Disk Drive), optical storage media (e.g., optical discs (CD: Compact Disc, DVD: Digital Versatile Disk)), magneto-optical storage media, and semiconductor memories. The programs may also be stored in an external server, such as a cloud server, and downloaded through a communication line, such as the Internet.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A detection device comprising:
a first detection unit that detects a leading edge portion and a trailing edge portion of a medium while the medium is being transported; and
a second detection unit that detects both edge portions of the medium in an orthogonal direction that is orthogonal to a transporting direction of the medium while the medium is being transported.

2. The detection device according to claim 1, further comprising:
a transport unit that transports the medium; and
an abutting unit that is disposed downstream of the transport unit in the transporting direction and against which a leading edge of the medium transported by the transport unit is abutted,
wherein the second detection unit is disposed downstream of the abutting unit in the transporting direction.

3. The detection device according to claim 1, wherein the second detection unit is divided into a section that detects one edge portion of the medium in the orthogonal direction and a section that detects other edge portion of the medium in the orthogonal direction, the sections facing each other in the orthogonal direction.

4. The detection device according to claim 2, wherein the second detection unit is divided into a section that detects one edge portion of the medium in the orthogonal direction and a section that detects other edge portion of the medium in the orthogonal direction, the sections facing each other in the orthogonal direction.

5. The detection device according to claim 3, wherein at least one of the sections into which the second detection unit is divided in the orthogonal direction detects an amount of displacement of the medium in the orthogonal direction.

6. The detection device according to claim 4, wherein at least one of the sections into which the second detection unit is divided in the orthogonal direction detects an amount of displacement of the medium in the orthogonal direction.

7. The detection device according to claim 1, further comprising:
an abutting unit against which a leading edge of the medium is abutted,
wherein the first detection unit is disposed upstream of the abutting unit in the transporting direction.

8. The detection device according to claim 2, wherein the first detection unit is disposed upstream of the abutting unit in the transporting direction.

9. The detection device according to claim 3, further comprising:
an abutting unit against which a leading edge of the medium is abutted,
wherein the first detection unit is disposed upstream of the abutting unit in the transporting direction.

10. The detection device according to claim 4, wherein the first detection unit is disposed upstream of the abutting unit in the transporting direction.

11. The detection device according to claim 5, further comprising:
an abutting unit against which a leading edge of the medium is abutted,
wherein the first detection unit is disposed upstream of the abutting unit in the transporting direction.

12. The detection device according to claim 6, wherein the first detection unit is disposed upstream of the abutting unit in the transporting direction.

13. The detection device according to claim 1,
wherein the first detection unit includes:
a leading edge sensing unit that senses the leading edge portion of the medium while the medium is being transported; and
a trailing edge sensing unit that includes a plurality of sensing elements arranged in the transporting direction and that senses the trailing edge portion of the medium while the medium is being transported, a distance between one of the plurality of sensing elements that is disposed most upstream in the transporting direction and the leading edge sensing unit being less than a transporting-direction dimension of the medium when the medium has a maximum size.

14. The detection device according to claim 2,
wherein the first detection unit includes:
a leading edge sensing unit that senses the leading edge portion of the medium while the medium is being transported; and
a trailing edge sensing unit that includes a plurality of sensing elements arranged in the transporting direction and that senses the trailing edge portion of the medium while the medium is being transported, a distance between one of the plurality of sensing elements that is disposed most upstream in the transporting direction and the leading edge sensing unit being less than a transporting-direction dimension of the medium when the medium has a maximum size.

15. The detection device according to claim 3,
wherein the first detection unit includes:
a leading edge sensing unit that senses the leading edge portion of the medium while the medium is being transported; and
a trailing edge sensing unit that includes a plurality of sensing elements arranged in the transporting direction and that senses the trailing edge portion of the medium while the medium is being transported, a distance between one of the plurality of sensing elements that is disposed most upstream in the transporting direction and the leading edge sensing unit being less than a transporting-direction dimension of the medium when the medium has a maximum size.

16. The detection device according to claim 4,
wherein the first detection unit includes:
a leading edge sensing unit that senses the leading edge portion of the medium while the medium is being transported; and
a trailing edge sensing unit that includes a plurality of sensing elements arranged in the transporting direction and that senses the trailing edge portion of the medium while the medium is being transported, a distance between one of the plurality of sensing elements that is disposed most upstream in the transporting direction and the leading edge sensing unit being less than a transporting-direction dimension of the medium when the medium has a maximum size.

17. The detection device according to claim 13, wherein the first detection unit includes two pairs of sensing units, each pair including the leading edge sensing unit and the trailing edge sensing unit that overlap when viewed in the transporting direction.

18. The detection device according to claim 14, wherein the transport unit transports the medium at a constant transport speed that is lower than a transport speed at which the medium is transported in a region upstream of the leading edge sensing unit in the transporting direction, and
wherein the leading edge sensing unit and the trailing edge sensing unit respectively sense the leading edge portion and the trailing edge portion of the medium while the medium is being transported by the transport unit.

19. The detection device according to claim 14, further comprising:
an upstream transport unit that is disposed upstream of the transport unit in the transporting direction and that is movable between a nipping position at which the upstream transport unit nips the medium and a separated position at which the upstream transport unit is separated from the medium, the upstream transport unit transporting the medium while the upstream transport unit is at the nipping position,
wherein the leading edge sensing unit and the trailing edge sensing unit respectively sense the leading edge portion and the trailing edge portion of the medium while the upstream transport unit is at the separated position.

20. A non-transitory computer readable medium storing a program causing a computer to execute a process comprising:
detecting a leading edge portion and a trailing edge portion of a medium while the medium is being transported; and
detecting both edge portions of the medium in an orthogonal direction that is orthogonal to a transporting direction of the medium while the medium is being transported.
